(19) United States
(12) Patent Application Publication
(10) Pub. No.: US 2025/0240397 A1
(43) Pub. Date: Jul. 24, 2025

(54) INFORMATION PROCESSING APPARATUS, INFORMATION PROCESSING METHOD, PROGRAM, AND INFORMATION PROCESSING SYSTEM

(71) Applicant: SONY GROUP CORPORATION, TOKYO (JP)

(72) Inventors: TAKAYUKI KURIHARA, TOKYO (JP); YUJI NAKAHATA, TOKYO (JP); TOMOYA YANO, TOKYO (JP); MASAMOTO HORIKAWA, TOKYO (JP)

(21) Appl. No.: 18/697,881

(22) PCT Filed: Aug. 18, 2022
(86) PCT No.: PCT/JP2022/031149

§ 371 Date: Apr. 2, 2024

(30) Foreign Application Priority Data
Oct. 13, 2021 (JP) 2021-168349

(51) Int. Cl. H04N 13/125; G06T 7/50; G06T 7/70; G06V 10/60; H04N 13/302

(52) U.S. Cl. CPC H04N 13/125; G06T 7/50; G06T 7/70; G06V 10/60; H04N 13/302

(57) ABSTRACT

An information processing apparatus according to an embodiment of the present technology includes an image generation unit. The image generation unit generates a confirmation image regarding crosstalk on the basis of a viewpoint position of a user. Further, the limitation on the viewing position is largely eliminated by tracking the user, and a suitable video corresponding to the viewing position of the user is displayed. Further, displaying a special pattern specialized for confirming the crosstalk makes it easy for the user to visually recognize the crosstalk. Further, since the user himself/herself can perform segmentation, a cause can be found more quickly. This makes it possible to achieve a high-quality viewing experience.

### TECHNICAL FIELD

The present technology relates to an information processing apparatus, an information processing method, a program, and an information processing system that are applicable to image display or the like.

### BACKGROUND ART

Patent Literature 1 describes a three-dimensional video display apparatus that displays a three-dimensional video for test on a display when an event requesting a check of a viewing position occurs. In the three-dimensional video for test, stereoscopic videos of a plurality of vertical bars arranged at respective positions having different depths are perceived when observed from a predetermined viewing region. This allows a user to easily confirm whether or not a current viewing position is in a 3D viewing region (paragraphs [0045] to [0061] of the specification, FIG. 7, and the like in Patent Literature 1).

### CITATION LIST

### Patent Literature

Patent Literature 1: Japanese Patent Application Laid-open No. 2012-249192

### DISCLOSURE OF INVENTION

### Technical Problem

There is a demand for a technology capable of achieving a high-quality viewing experience in such a display apparatus capable of viewing a stereoscopic image.

In view of the circumstances as described above, it is an object of the present technology to provide an information processing apparatus, an information processing method, a program, and an information processing system that are capable of achieving a high-quality viewing experience.

### Solution to Problem

In order to achieve the above object, an information processing apparatus according to one embodiment of the present technology includes an image generation unit.

The image generation unit generates a confirmation image regarding crosstalk on the basis of a viewpoint position of a user.

In this information processing apparatus, a confirmation image regarding crosstalk is generated on the basis of a viewpoint position of a user. This makes it possible to achieve a high-quality viewing experience.

The confirmation image may include a left-eye image that enters a left eye of the user, and a right-eye image that enters a right eye of the user and is different from the left-eye image.

The left-eye image may include a predetermined pattern. In this case, the right-eye image may include a predetermined pattern. Further, the predetermined pattern may include at least one of a position of an object, a luminance of the object, a depth of the object, or a shape of the object.

The information processing apparatus may further include a determination unit that determines whether the user is closing the left eye or the right eye on the basis of a captured image in which the user appears.

The image generation unit may generate, on the basis of a determination result of the determination unit, the confirmation image based on a difference threshold of the user.

The image generation unit may generate the confirmation image including the predetermined pattern with which whether the user performs visual recognition with the left eye or the right eye can be confirmed.

The image generation unit may generate, on the basis of a determination result of the determination unit, the left-eye image or the right-eye image that includes luminance information regarding a crosstalk value when an inspection is performed at a predetermined timing.

The confirmation image may be an image based on a display parameter regarding display of the predetermined pattern. In this case, the image generation unit may generate the left-eye image or the right-eye image that is based on a first display parameter when an inspection is performed at a predetermined timing, and generate another image that is based on a second display parameter different from the first display parameter.

The information processing apparatus may further include a guide image generation unit that generates, on the basis of the viewpoint position, a guide image that guides the user to a position suitable to observe the confirmation image.

An information processing method according to one embodiment of the present technology is an information processing method executed by a computer system, the information processing method including generating a confirmation image regarding crosstalk on the basis of a viewpoint position of a user.

A recording medium that describes a program according to one embodiment of the present technology causes a computer system to execute the following step of generating a confirmation image regarding crosstalk on the basis of a viewpoint position of a user.

An information processing system according to one embodiment of the present technology includes a camera, an information processing apparatus, and an image display apparatus.

The camera captures an image of a user.

The information processing apparatus includes an image generation unit that generates a confirmation image regarding crosstalk on the basis of a viewpoint position of the user.

The image display apparatus displays the confirmation image.

The camera may capture the confirmation image reflected by a mirror. In this case, the information processing apparatus may include a crosstalk determination unit that determines occurrence and degree of the crosstalk on the basis of the reflected confirmation image.

The image display apparatus may display, for the user, an image formed from a left-eye image and a right-eye image. In this case, the information processing apparatus may include a second image generation unit that generates an image that guides the user to a position suitable to observe the image.

### BRIEF DESCRIPTION OF DRAWINGS

FIG. 1 is a diagram schematically showing a glasses-free stereoscopic display and confirmation images.

FIG. 2 is a block diagram showing a configuration example of the glasses-free stereoscopic display and an information processing apparatus.

FIG. 3 is a flow showing an example of an execution timing of an evaluation application.

FIG. 4 is a flow showing an example of a case where the evaluation application is executed on the basis of a determination.

FIG. 5 is a schematic diagram showing examples of a confirmation image in which a difference threshold is considered.

FIG. 6 is a schematic diagram showing an example of a confirmation image in which the left and the right are easily perceived.

FIG. 7 is a schematic diagram showing a confirmation image for evaluating a level of crosstalk.

FIG. 8 is a schematic diagram showing examples of a confirmation image when a display parameter of a predetermined pattern is changed.

FIG. 9 is a schematic diagram showing other examples of a confirmation image when the display parameter is changed.

FIG. 10 is a diagram showing a flowchart and a guide image when a user is guided to a recommended observation position.

FIG. 11 is a schematic diagram showing an example of determining the crosstalk by the system side.

FIG. 12 is a schematic diagram showing another example of the confirmation image.

FIG. 13 is a schematic diagram showing an example of an image for guiding the user to a confirmation position.

FIG. 14 is a block diagram showing a hardware configuration example of the information processing apparatus.

### MODE(S) FOR CARRYING OUT THE INVENTION

Hereinafter, an embodiment according to the present technology will be described with reference to the drawings.

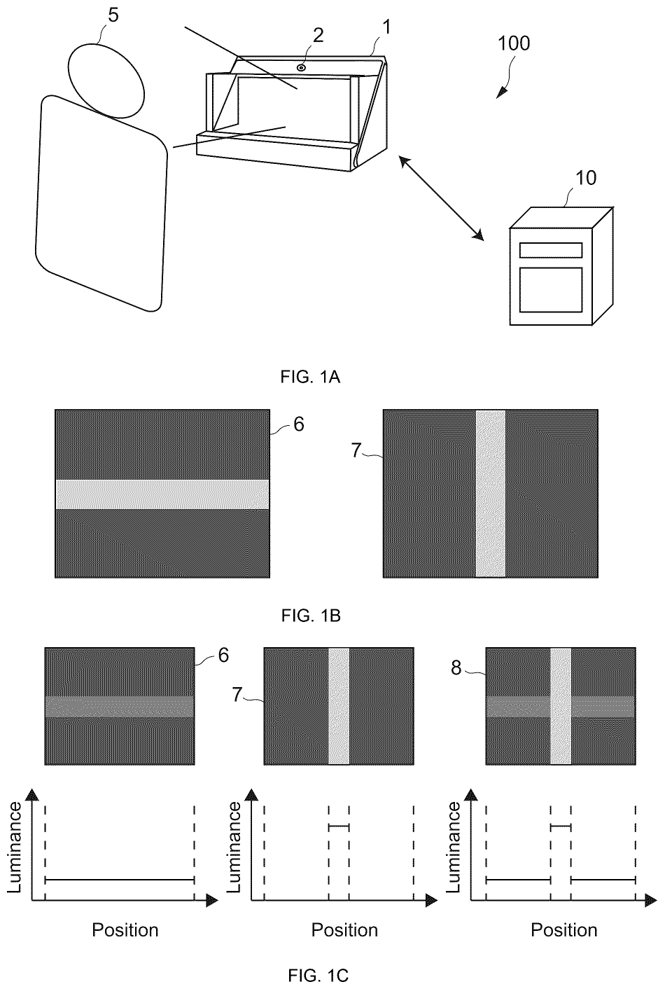

FIG. 1 is a diagram schematically showing a glasses-free stereoscopic display (glasses-free stereoscopic image display apparatus) and confirmation images according to the present technology. A of FIG. 1 is a diagram schematically showing an information processing system 100. B of FIG. 1 is a diagram schematically showing confirmation images. C of FIG. 1 is a diagram schematically showing crosstalk.

As shown in A of FIG. 1, the information processing system 100 includes a glasses-free stereoscopic display 1 and an information processing apparatus 10.

The glasses-free stereoscopic display 1 is a display apparatus capable of displaying a stereoscopic image. A user 5 can view a stereoscopic three-dimensional video by viewing different parallax images from different viewpoints with the right eye and the left eye by using the glasses-free stereoscopic display 1.

In this embodiment, the glasses-free stereoscopic display 1 includes a camera 2. In this embodiment, the user 5 is imaged by the camera 2, and the captured image is supplied to the information processing apparatus 10. The information processing apparatus 10 acquires position information of the user 5 on the basis of the captured image of the user 5 acquired by the camera 2.

The position information includes a position of a viewpoint of the user 5, a direction of a line of sight, a position of the face of the user 5, and the like. In addition to the above, the glasses-free stereoscopic display 1 may have a configuration capable of tracking, such as a depth camera or a human sensor for acquiring the position information of the user 5.

The information processing apparatus 10 generates a confirmation image regarding crosstalk on the basis of the viewpoint position of the user 5. The confirmation image is an image that prompts the user 5 to determine whether or not crosstalk is generated. In this embodiment, the confirmation image includes a right-eye image that enters the right eye of the user 5, and a left-eye image that enters the left eye of the user 5 and is different from the right-eye image. The confirmation image displays a predetermined pattern with which crosstalk can be confirmed.

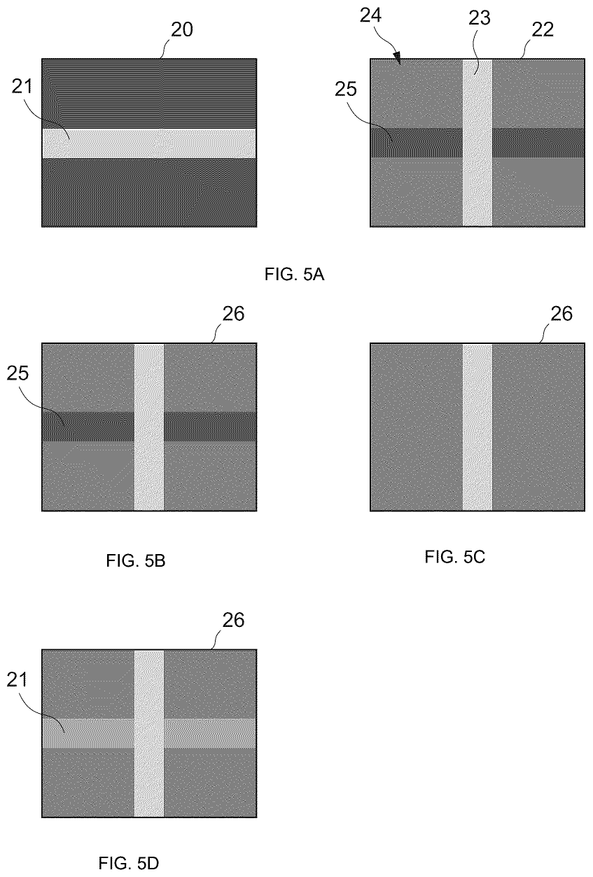

The predetermined pattern includes at least one of the position of an object, the luminance of the object, the depth of the object, or the shape of the object. For example, the predetermined pattern includes a stripe object having a large parallax amount or large contrast, an object in consideration of a difference threshold such as color or luminance (brightness of video), different objects that are easily perceived using a right-eye image and a left-eye image, and the like. For example, in B of FIG. 1, a left-eye image 6 and a right-eye image 7 display different horizontal and vertical stripes, respectively. In addition to the above, an example of the pattern of the confirmation image will be described later with reference to FIGS. 5 to 13.

In this embodiment, patterns in a case where confirmation is performed with one eye being closed and a case where confirmation is performed with both eyes being opened will be described. For example, if no crosstalk is generated when the user 5 is closing the left eye, the left-eye image 6 shown in B of FIG. 1 does not leak to the right eye, and thus the user 5 can view only the right-eye image 7.

Further, if crosstalk is generated when the user 5 is closing the left eye, the left-eye image 6 leaks to the right eye of the user 5. For example, as shown in C of FIG. 1, the user 5 views a confirmation image 8, which is an image in which the left-eye image 6 that leaks to the right eye of the user 5 is added to the right-eye image 7. The luminance of the pattern (horizontal strip) of the left-eye image 6 in C of FIG. 1 changes in accordance with the amount of crosstalk.

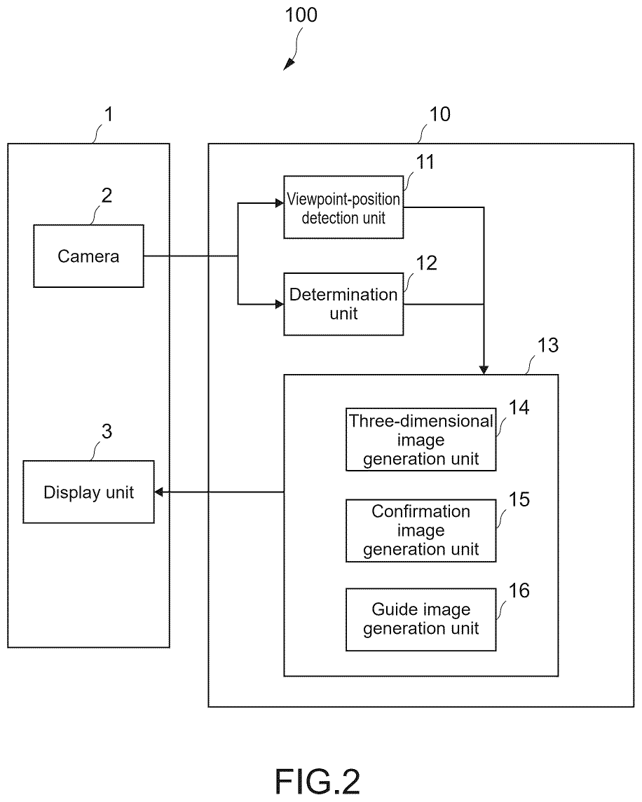

FIG. 2 is a block diagram showing a configuration example of the glasses-free stereoscopic display 1 and the information processing apparatus 10.

As shown in FIG. 2, the glasses-free stereoscopic display 1 includes a camera 2 and a display unit 3.

The camera 2 images a user. In this embodiment, a captured image captured by the camera 2 is supplied to a viewpoint-position detection unit 11 and a determination unit 12.

The display unit 3 displays content for the glasses-free stereoscopic display 1. For example, the user can view content, such as a moving image or a still image, as a stereoscopic image. In this embodiment, the display unit 3 displays a confirmation image when an evaluation application (app) for confirming crosstalk is activated.

The information processing apparatus 10 includes the viewpoint-position detection unit 11, the determination unit 12, and an image generation unit 13.

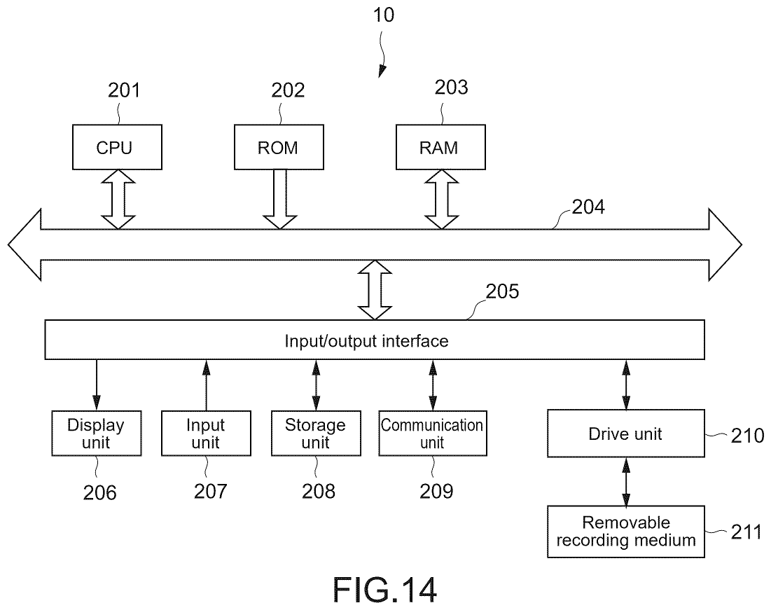

The information processing apparatus 10 includes hardware necessary for the configuration of a computer, for example, a CPU and a processor such as a GPU or a DSP, memories such as a ROM and a RAM, and a storage device such as an HDD (see FIG. 14). For example, the CPU loads a program according to the present technology, which is recorded in advance on the ROM or the like, to the RAM and executes the program, so that an information processing method according to the present technology is executed.

For example, it is possible to implement the information processing apparatus 10 by any computer such as a PC. As a matter of course, hardware such as a FPGA or an ASIC may be used.

In this embodiment, the CPU executes a predetermined program, thus configuring an image generation unit as a functional block. As a matter of course, in order to implement a functional block, dedicated hardware such as an integrated circuit (IC) may be used.

The program is installed on the information processing apparatus 10, for example, via various recording media. Alternatively, the program may be installed via the Internet or the like.

The type or the like of recording media on which programs are recorded is not limited, and any computer-readable recording media may be used. For example, any non-transitory computer-readable recording media may be used.

The viewpoint-position detection unit 11 detects a viewpoint position of the user. In this embodiment, the viewpoint-position detection unit 11 detects a viewpoint position of the user 5 on the basis of the captured image captured by the camera 2. The detected viewpoint position is supplied to the image generation unit 13. Note that the method of detecting a viewpoint position is not limited, and a viewpoint position may be detected by any method such as image analysis or machine learning.

The determination unit 12 determines whether the right eye or the left eye of the user is closed on the basis of the captured image. Further, the determination unit 12 determines whether or not a predetermined condition for activating the evaluation app is met. For example, conditions such as the number of times of movement of the head of the user, the number of times of movement of the head within a predetermined period of time, the amount of movement of the head, and the number of times of blinking are set, and the determination unit 12 determines whether or not those numbers of times described above exceed a threshold value, and the evaluation app is activated. In addition to the above, a predetermined condition may be discretionally set.

The image generation unit 13 includes a three-dimensional image generation unit 14, a confirmation image generation unit 15, and a guide image generation unit 16.

The three-dimensional image generation unit 14 generates a right-eye image and a left-eye image that are related to the content of the glasses-free stereoscopic display 1. In other words, a right-eye image that enters the right eye and a left-eye image that enters the left eye are generated in order to view a video work or the like as a stereoscopic image. The generated image is supplied to the display unit 3.

The confirmation image generation unit 15 generates a confirmation image. In this embodiment, the confirmation image generation unit 15 generates a suitable confirmation image on the basis of the viewpoint position of the user detected by the viewpoint-position detection unit 11. For example, as a result of a determination result of the determination unit 12, that is, in accordance with the case where the right eye or the left eye is closed, the confirmation image generation unit 15 generates a confirmation image for an opened eye. The generated confirmation image is supplied to the display unit 3.

The guide image generation unit 16 generates a guide image for guiding the user to a position suitable for observation of the confirmation image. In this embodiment, the guide image generation unit 16 generates a guide image on the basis of the viewpoint position of the user detected by the viewpoint-position detection unit 11. The generated guide image is supplied to the display unit 3.

Note that in this embodiment the glasses-free stereoscopic display 1 corresponds to an image display apparatus that displays the confirmation image.

Note that in this embodiment the camera 2 corresponds to a camera that captures an image of a user.

Note that in this embodiment the determination unit 12 corresponds to a determination unit that determines whether the user is closing the left eye or the right eye on the basis of the captured image in which the user appears.

Note that in this embodiment the confirmation image generation unit 15 corresponds to an image generation unit that generates a confirmation image regarding crosstalk on the basis of the viewpoint position of the user.

Note that in this embodiment the guide image generation unit 16 corresponds to a guide image generation unit that generates, on the basis of the viewpoint position, a guide image that guides a user to a position suitable to observe the confirmation image.

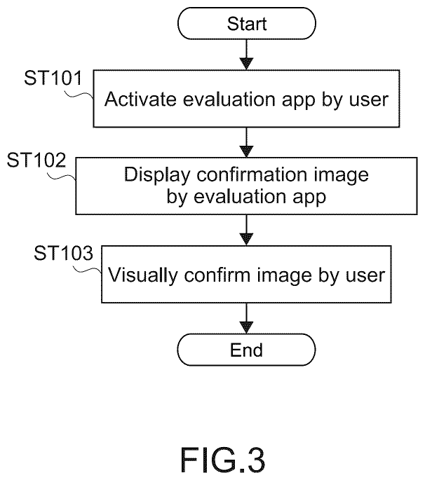

FIG. 3 is a flow showing an example of an execution timing of an evaluation app. In FIG. 3, a flow of a case where determination of crosstalk is started by an operation of the user is described.

As shown in FIG. 3, the evaluation app is activated by the user (Step 101). For example, when the user recognizes the occurrence of crosstalk such as deterioration in image quality or loss of fusion of left- and right-eye videos while viewing the content, the user activates the evaluation app.

When the evaluation app is activated, the confirmation image generation unit 15 displays the confirmation image on the display unit 3 (Step 102). The displayed confirmation image is visually confirmed by the user, and whether or not crosstalk is generated is confirmed (Step 103).

Typically, it is difficult for a person who is not used to seeing crosstalk to determine whether or not crosstalk is generated, but it is possible to easily perform determination by visually confirming the confirmation image.

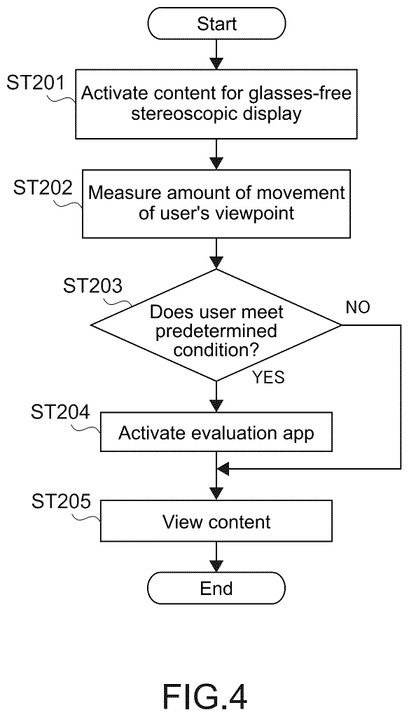

FIG. 4 is a flow showing an example of a case where the evaluation app is executed on the basis of the determination.

As shown in FIG. 4, content for the glasses-free stereoscopic display 1 is activated by the user (Step 201).

The viewpoint-position detection unit 11 measures the amount of movement of the user's viewpoint (head) on the basis of the captured image of the user acquired form the camera 2 (Step 202).

The determination unit 12 determines whether or not the user meets a predetermined condition for activating the evaluation app (Step 203). For example, the determination unit 12 determines whether or not the difference between the position information of the head of the user when the content is activated and the position information of the head of the user when the user moves, which are detected by the viewpoint-position detection unit 11, exceeds a threshold value.

If the user meets a predetermined condition (YES in Step 203), the evaluation app is activated (Step 204). In this embodiment, the wording for prompting the user to perform an evaluation is displayed on the display unit 3. For example, wording such as “There is a possibility that crosstalk is generated.” or “Is it hard to see the video?” is displayed on the display unit 3. In addition to the above, the wording may be audibly presented to the user from a speaker.

If the evaluation app is activated, the confirmation image is displayed on the display unit 3. Hereinafter, FIGS. 5 to 9 show examples of the confirmation image to be displayed on the display unit 3. Further, in the examples of FIGS. 5 to 7, it is assumed that the user is closing one eye. For example, wording such as “Close one eye.” is displayed on the display unit 3, and the determination unit 12 determines whether or not the user is closing one eye on the basis of the captured image. This makes it easier for the user to recognize crosstalk.

FIG. 5 is a schematic diagram showing examples of the confirmation image in which a difference threshold is considered. A of FIG. 5 is a schematic diagram showing a left-eye image and a right-eye image. B of FIG. 5 is a schematic diagram showing a confirmation image when crosstalk is small. C of FIG. 5 is a schematic diagram showing a confirmation image when the amount of crosstalk at the time of shipping is generated. D of FIG. 5 is a schematic diagram showing a confirmation image when crosstalk is large.

In FIG. 5, a situation in which the user is closing the left eye is taken as an example. Hereinafter, an opened eye will be referred to as an observation side.

As shown in A of FIG. 5, a left-eye image 20 is an image including a pattern of a horizontal stripe 21. A right-eye image 22 is an image including a pattern of a vertical stripe 23 and a colored background 24. Further, the right-eye image 22 includes a pattern of a horizontal stripe 25 having a different color from and at the same position as the horizontal stripe 21 of the left-eye image 20. The horizontal stripe 25 is colored on the basis of the difference threshold of the user. Note that in FIG. 5 the background 24 is displayed in black, but the present technology is not limited thereto, and the background 24 may be white.

As shown in B of FIG. 5, if the crosstalk is smaller than the crosstalk at the time of shipping, the left-eye video 20 does not leak to the right eye, and thus the user can visually recognize the horizontal stripe 25 of the right-eye image 22, as shown in a confirmation image 26.

As shown in C of FIG. 5, if the crosstalk corresponds to the crosstalk at the time of shipping, a leak from the left-eye image 20 is added to the right-eye image 22. In other words, the horizontal stripe 21 of the left-eye image 20 and the horizontal stripe 25 of the right-eye image 22 are combined, and a confirmation image 26 that is the same as the background 24 of the right-eye image 22 is visually recognized.

As shown in D of FIG. 5, if the crosstalk is larger than the crosstalk at the time of shipping, the amount of leak from the left-eye image 20 increases. In other words, the luminance of the left-eye image 20 is high, and the luminance of the horizontal stripe 21 is visually recognized in a state brighter than the background 24.

Whether or not the horizontal stripe 25 can be visually recognized varies depending on the user. However, in the case of the confirmation images based on the difference threshold shown in FIG. 5, it is easier to determine whether or not the crosstalk is generated.

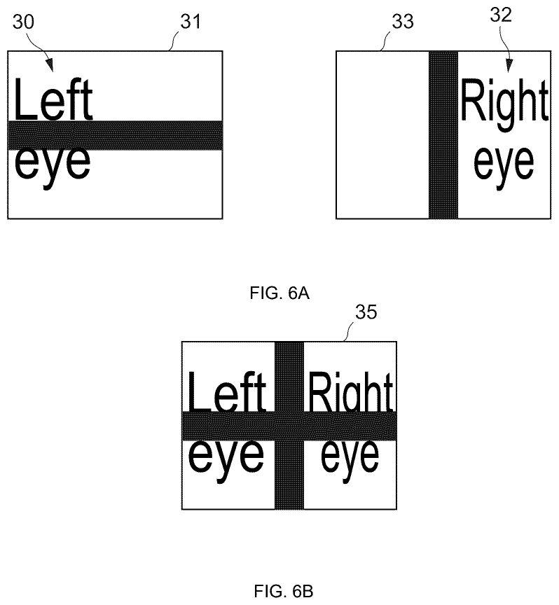

FIG. 6 is a schematic diagram showing an example of a confirmation image in which the left and the right are easily perceived. A of FIG. 6 is a schematic diagram showing a left-eye image and a right-eye image. B of FIG. 6 is a schematic diagram showing a confirmation image actually viewed by the user.

In FIG. 6, a predetermined pattern for confirming whether or not a user who needs to close one eye when determining crosstalk is actually closing one eye, that is, whether or not the user is observing a confirmation image in an assumed state, is displayed.

For example, as shown in A of FIG. 6, a left-eye image 31 including wording 30 of “left eye” and a right-eye image 33 including wording 32 of “right eye” are displayed on the display unit 3. If the user is not closing one eye, the user observes a confirmation image 35 shown in B of FIG. 6.

If the user is closing the left eye, the user observes only the right-eye image 33. This makes it possible for the user to recognize and point out crosstalk by reliably closing one eye.

Note that the pattern in which the left and the right are easily perceived is not limited. For example, when the evaluation app is activated, notification may be performed by voice or wording such as a circular symbol viewed when the right eye is closed, or a rectangle symbol viewed when the left eye is closed.

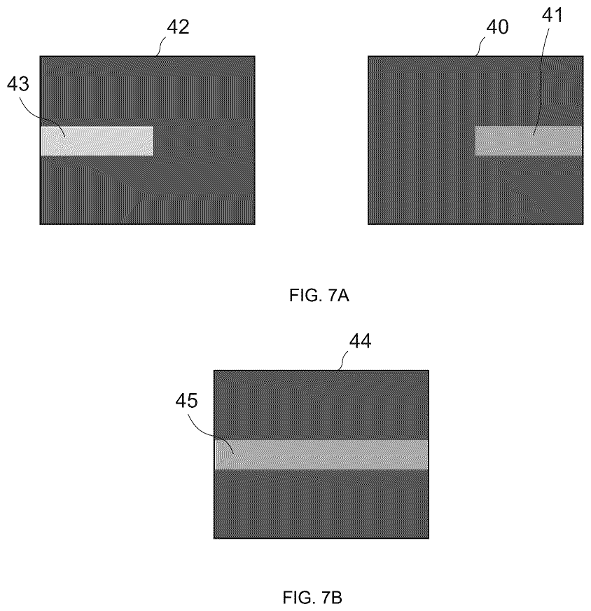

FIG. 7 is a schematic diagram showing a confirmation image for evaluating the level (degree) of crosstalk. A of FIG. 7 is a schematic diagram showing a left-eye image and a right-eye image. B of FIG. 7 is a schematic diagram showing a confirmation image that is actually viewed by the user.

In FIG. 7, a situation in which the user is closing the left eye is taken as an example. As shown in A of FIG. 7, a right-eye image 40 that enters the eye of the observation side includes a pattern of a horizontal stripe 41 that is displayed at a luminance level equivalent to the crosstalk value during the pre-shipment inspection of the glasses-free stereoscopic display 1. Further, a left-eye image 42 includes a pattern of a horizontal stripe 43 for generating crosstalk.

As shown in B of FIG. 7, the user can confirm the level of crosstalk as compared with the state at the time of shipping by observing a confirmation image 44. If the level of crosstalk is normal, the user can observe a pattern 45 in which the horizontal stripe 41 and the horizontal stripe 43 have the same luminance as shown in the confirmation image 44.

In other words, if the level of crosstalk in the initial state at the time of shipping or the like is recorded, the user can easily determine the level by referring to the level.

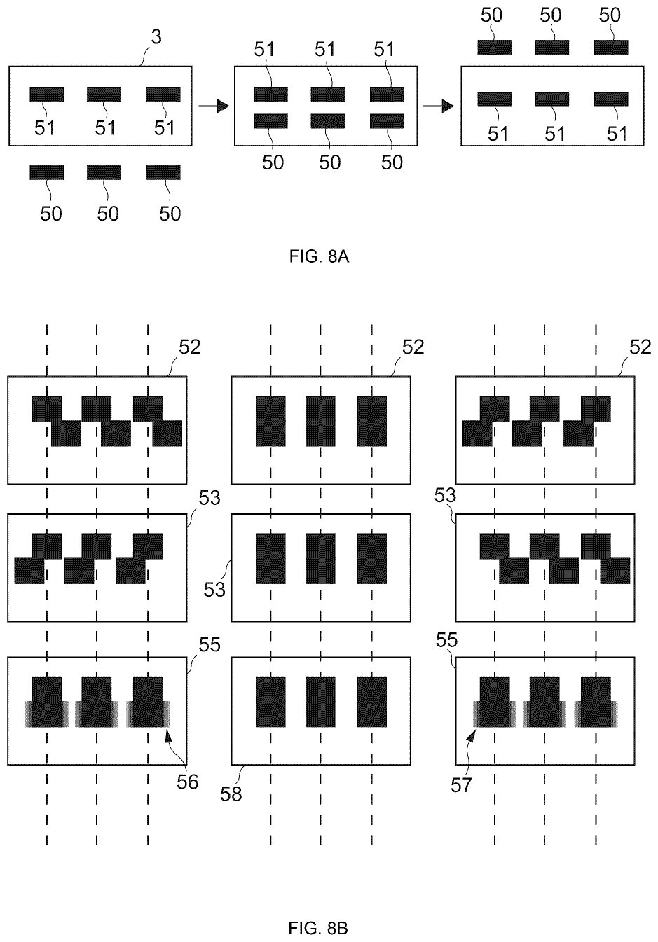

FIG. 8 is a schematic diagram showing examples of a confirmation image when a display parameter of a predetermined pattern is changed. A of FIG. 8 is a schematic diagram showing an example of a confirmation image. B of FIG. 8 is a schematic diagram showing confirmation images when a displayed parameter is changed.

The display parameter is a parameter regarding display of a predetermined pattern. For example, the display parameter includes the depth or luminance of an object (pattern 50 of FIG. 8), the position of an object to be displayed (coordinates in the vertical direction and coordinates in the horizontal direction), and the like.

In FIG. 8, a situation in which the user is opening both eyes is taken as an example. In an confirmation image shown in FIG. 8, patterns 50 and 51 displayed in a right-eye image and a left-eye image have different display parameters. In this embodiment, as shown in B of FIG. 8, a left-eye image 52 and a right-eye image 53 including patterns having the same shape and different depths are displayed. In other words, as shown in A of FIG. 8, the user observes a state in which patterns (squares 50) are displayed in front of the display unit 3 or the patterns 50 are displayed on the deep side of the display unit.

Further, as shown in B of FIG. 8, if the display parameter is changed such that the patterns 50 are displayed in front, the user visually recognizes the patterns 50 (regions 56) in a low luminance state. Similarly, if the display parameter is changed such that the patterns 50 are displayed on the deep side, the user visually recognizes regions 57. In other words, in the example of FIG. 8, if the depth of the patterns 50 is changed, a confirmation image 58 showing an ideal state in which crosstalk is not generated is displayed. This makes it possible for the user to observe a change of a region in which crosstalk is generated.

Note that the change in the depth of the pattern may be automatically changed or may be changed by the user himself/herself. Further, the change in the display parameter may be changed on the basis of the level of crosstalk in the initial state.

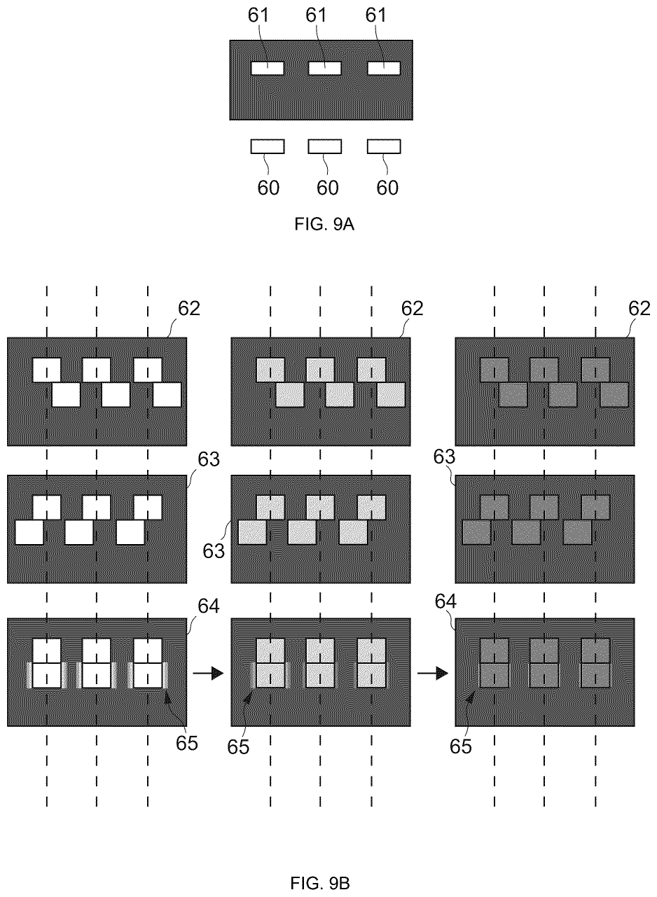

FIG. 9 is a schematic diagram showing other examples of a confirmation image when the display parameter is changed. A of FIG. 9 is a schematic diagram showing an example of a confirmation image. B of FIG. 9 is a schematic diagram showing confirmation images when a display parameter is changed.

In FIG. 9, a situation in which the user is opening both eyes is taken as an example. In FIG. 9, as the display parameter of the confirmation image, the luminance of patterns 60 and 61 is changed. Further, in FIG. 9, as shown in A of FIG. 9, the depth of the pattern 60 is set on the near side for display.

In this embodiment, as shown in B of FIG. 9, a left-eye image 62 and a right-eye image 63 include patterns having the same shape and the same luminance. When the user observes the left-eye image 62 and the right-eye image 63, if crosstalk is generated, a region 65 that is blurred occurs as in a confirmation image 64.

The luminance of the patterns 60 and 61 is changed, and the user confirms the luminance at which no crosstalk can be observed. This makes it possible to grasp the degree (level) of crosstalk being generated.

The user visually confirms the confirmation images shown in FIGS. 5 to 9, so that the generation and degree of crosstalk are confirmed. The user terminates the confirmation of the crosstalk to view the content (Step 205).

Hereinabove, in the information processing apparatus 10 according to this embodiment, the confirmation image regarding crosstalk is generated on the basis of the viewpoint position of the user 5. This makes it possible to achieve a high-quality viewing experience.

Conventionally, a display apparatus that allows a stereoscopic image or the like to be viewed, such as a glasses-free stereoscopic display, limits a viewing position from which the stereoscopic image can be viewed correctly. Further, the occurrence of crosstalk has influence on the image quality and fusion of 3D videos. However, it is difficult for a person who is not used to seeing crosstalk to determine whether or not crosstalk is generated.

In the present technology, the limitation on the viewing position is largely eliminated by tracking the user, and a suitable video corresponding to the viewing position of the user is displayed. Further, displaying a special pattern specialized for confirming the crosstalk makes it easy for the user to visually recognize the crosstalk. Further, since the user himself/herself can perform segmentation, a cause can be found more quickly.

### Other Embodiments

The present technology is not limited to the embodiment described above and can achieve various other embodiments.

In the embodiment described above, the viewpoint-position detection unit 11 is mounted on the information processing apparatus 10. The present technology is not limited to the above, and the viewpoint-position detection unit 11 may be mounted on the glasses-free stereoscopic display 1. This makes it possible to reduce the load on the information processing apparatus 10.

In the embodiment described above, the image generation unit 13 is mounted on the information processing apparatus 10. The present technology is not limited to the above, and the image generation unit 13 may be mounted on the glasses-free stereoscopic display 1. For example, the information processing apparatus 10 may generate, on the basis of the viewpoint position of the user, only the left-eye image and the right-eye image that are input from 3D object data to the three-dimensional image generation unit 14. This makes it possible to further reduce the load on the information processing apparatus 10.

In other words, the processing executed by the viewpoint-position detection unit 11 and the image generation unit 13 may be processed by either the glasses-free stereoscopic display 1 or the information processing apparatus 10. For example, in the case where the viewpoint-position detection unit 11 and the image generation unit 13 are mounted on the information processing apparatus 10, the glasses-free stereoscopic display 1 does not need to mount a dedicated FPGA or the like, which reduces costs. Further, for example, in the case where the viewpoint-position detection unit 11 and the image generation unit 13 are mounted on the glasses-free stereoscopic display 1, most processing for three-dimensional display is performed by the glasses-free stereoscopic display 1, so that the load on the information processing apparatus 10 can be reduced.

In the embodiment described above, the camera 2 is mounted on the glasses-free stereoscopic display 1. The present technology is not limited to the above, and a configuration capable of tracking the user, such as a camera, may be externally provided. For example, the camera and the glasses-free stereoscopic display 1 may be connected via wires or wirelessly to supply a captured image.

In the embodiment described above, the confirmation image regarding crosstalk is generated for the user. The present technology is not limited to the above, and a guide image for guiding the user to a recommended observation position may be generated.

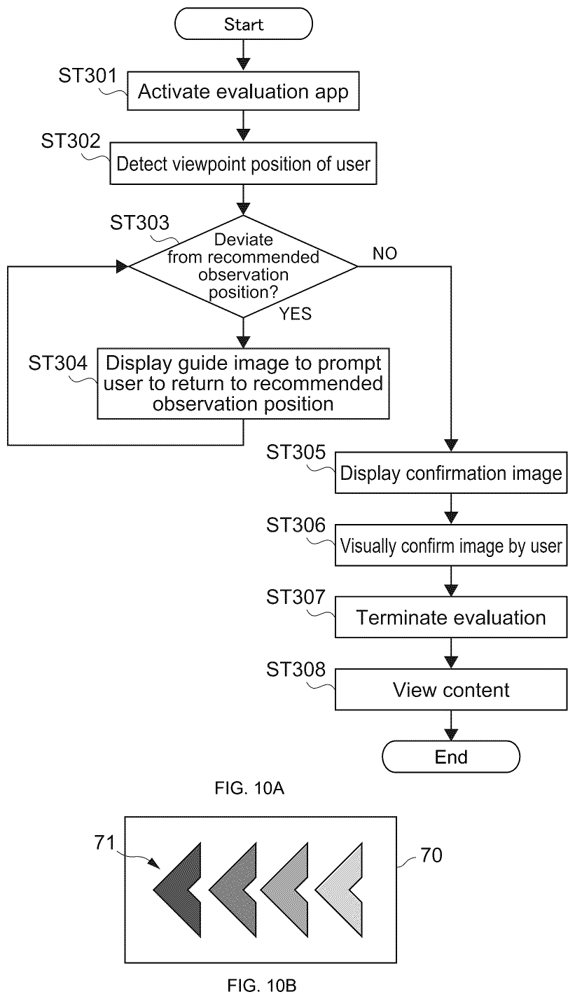

FIG. 10 is a diagram showing a flowchart and a guide image when a user is guided to a recommended observation position. A of FIG. 10 is a flowchart when a user is guided to a recommended observation position. B of FIG. 10 is a diagram showing a guide image.

As shown in A of FIG. 10, according to the flow shown in FIG. 3 or 4, an evaluation app is activated (Step 301). The viewpoint-position detection unit 11 detects a viewpoint position of the user (Step 302).

If the viewpoint position of the user deviates from a recommended observation position (YES in Step 303), the guide image generation unit 16 generates a guide image 70 to prompt the user to return to the recommended observation position, and the guide image 70 is displayed on the display unit 3 (Step 304).

The recommended observation position is a position suitable to observe the content for the glasses-free stereoscopic display 1. In this embodiment, it is possible to present a video in accordance with the viewing position by tracking the user. In other words, it is not necessary for the user himself/herself to find an optimal viewing position. However, there is a possibility that the user observes an unsuitable video if the viewing position significantly deviates from the recommended observation position. Guiding the user to the recommended observation position using the guide image makes it possible to more accurately confirm whether or not crosstalk is generated.

In B of FIG. 10, it is assumed that the user deviates rightward from the recommended observation position. In this case, as shown in B of FIG. 10, a guide image 70 for guiding the user to a leftward direction is displayed. For example, in the guide image 70, an arrow 71 indicating a direction in which the user is to be guided and a moving distance of the user are shown by grayscale of the arrow 71. As a matter of course, the guide image is not limited and may be an image or the like of contents for guiding the user to a position where wording or an image can be seen correctly.

If the user is located at the recommended observation position by the guide of the guide image 70 (YES in Step 303), the confirmation image is displayed (Step 305). The user visually confirms the confirmation image shown in FIGS. 5 to 9 to confirm the occurrence and degree of crosstalk (Step 306). The user terminates the evaluation app (Step 307) and views the content (Step 308).

In the embodiment described above, the user observes the confirmation image and determines whether or not crosstalk is generated. The present technology is not limited to the above, and the occurrence of crosstalk may be determined by the system side.

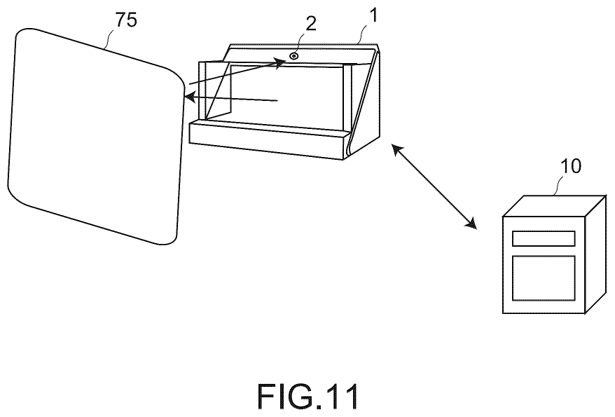

FIG. 11 is a schematic diagram showing an example of determining the crosstalk by the system side.

As shown in FIG. 11, a mirror 75 is disposed in front of the glasses-free stereoscopic display 1. The mirror 75 reflects a confirmation image emitted from the glasses-free stereoscopic display 1. The camera 2 mounted on the glasses-free stereoscopic display 1 captures an image of the confirmation image reflected on the mirror 75. For example, the information processing apparatus 10 may include a crosstalk determination unit that determines the occurrence and degree of crosstalk on the basis of the captured image of the confirmation image. For example, the crosstalk determination unit determines the occurrence of crosstalk on the basis of whether the crosstalk is equal to or less than a preset allowable value.

This makes it possible to eliminate a gap in determination as to whether or not crosstalk is generated, the determination being performed by each user. Note that the mirror 75 may be mounted on the glasses-free stereoscopic display 1 or may be prepared by the user.

In the embodiment described above, the pattern of the confirmation image is displayed at the center. The present technology is not limited to the above, and the shape, position, or the like of the pattern of the confirmation image may be discretionally set.

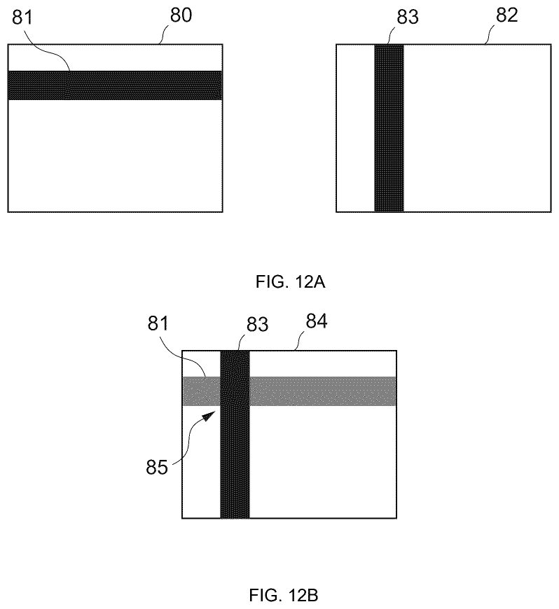

FIG. 12 is a schematic diagram showing another example of the confirmation image. A of FIG. 12 is a schematic diagram showing a right-eye image and a left-eye image. B of FIG. 12 is a schematic diagram showing a confirmation image that is actually viewed by the user.

For example, as shown in A of FIG. 12, a horizontal stripe 81 and a vertical stripe 83 of a left-eye image 80 and a right-eye image 82 may be displayed outside the center. In this case, the user can observe a confirmation image 84 shown in B of FIG. 12. The determination on the presence or absence of crosstalk in this case is performed for a location 85 where the horizontal stripe 81 and the vertical stripe 83 intersect with each other. Further, the pattern included in the confirmation image may be displayed at a plurality of locations.

This makes it possible for the user to grasp the degree of crosstalk that varies depending on each position on the screen.

In the embodiment described above, the guide image is displayed in order to guide the user to a recommended observation position. The present technology is not limited to the above, and an image for guiding the user to a confirmation position that is suitable to confirm crosstalk may be displayed.

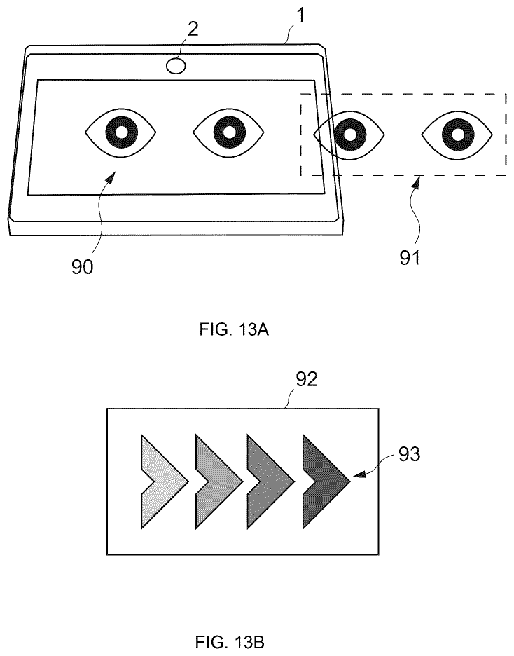

FIG. 13 is a schematic diagram showing an example of an image for guiding the user to a confirmation position. A of FIG. 13 is a schematic diagram showing a viewing position of the user. B of FIG. 13 is a schematic diagram showing an example of the image.

For example, the viewpoint-position detection unit 11 detects a current viewing position 90 of the user. As shown in A of FIG. 13, when a confirmation position 91 suitable to confirm crosstalk is located on the right side relative to the viewing position 90, an image 92 shown in B of FIG. 13 is displayed. For example, in the image 92, an arrow 93 indicating a direction in which the user is to be guided and a moving distance of the user are shown by grayscale of the arrow 93.

Since the degree of crosstalk varies according to the position or angle at which the user observes the display, if the user is guided to the confirmation position at a suitable angle as shown in FIG. 13, the degree of crosstalk when viewed from the respective positions can be grasped. Further, when the image is displayed, the user him/herself does not need to determine a suitable position when confirming crosstalk, which can improve the usability.

FIG. 14 is a block diagram showing a hardware configuration example of the information processing apparatus 10.

The information processing apparatus 10 includes a CPU 201, a ROM 202, a RAM 203, an input/output interface 205, and a bus 204 that connects those components to each other. A display unit 206, an input unit 207, a storage unit 208, a communication unit 209, a drive unit 210, and the like are connected to the input/output interface 205.

The display unit 206 is, for example, a display device using liquid crystal, electro-luminescence (EL), or the like. The input unit 207 is, for example, a keyboard, a pointing device, a touch panel, or another operation device. If the input unit 207 includes a touch panel, the touch panel may be integrated with the display unit 206.

The storage unit 208 is a nonvolatile storage device and is, for example, an HDD, a flash memory, or another solid-state memory. The drive unit 210 is, for example, a device capable of driving a removable recording medium 211 such as an optical recording medium or a magnetic recording tape.

The communication unit 209 is a modem, a router, or another communication device that can be connected to a LAN, a WAN, or the like for communicating with other devices. The communication unit 209 may communicate using wires or radios. The communication unit 209 is often used separately from the information processing apparatus 10.

The information processing by the information processing apparatus 10 having the hardware configuration as described above is implemented in cooperation with the software stored in the storage unit 208, the ROM 202, or the like, and the hardware resource of the information processing apparatus 10. Specifically, the information processing method according to the present technology is implemented when a program stored in the ROM 202 or the like and configuring the software is loaded to the RAM 203 and then executed.

The program is installed in the information processing apparatus 10, for example, through the recording medium 211. Alternatively, the program may be installed in the information processing apparatus 10 via a global network or the like. In addition, any non-transitory computer-readable storage medium may be used.

The information processing method and the program according to the present technology may be executed, and the image generation unit according to the present technology may be constructed, by linking a computer mounted on a communication terminal with another computer capable of communicating via a network or the like.

In other words, the information processing system, the information processing apparatus, and the information processing method according to the present technology can be executed not only in a computer system including a single computer but also in a computer system in which a plurality of computers operates in conjunction with each other. Note that, in the present disclosure, a system means a collection of a plurality of constituent elements (apparatuses, modules (components), and the like), and whether or not all the constituent elements are in the same housing is not limited. Therefore, a plurality of apparatuses accommodated in separate housings and connected to each other through a network, and a single apparatus in which a plurality of modules is accommodated in a single housing are both the system.

The execution of the information processing apparatus, the information processing method, the program, and the information processing system according to the present technology by a computer system include, for example, both a case where the detection of a viewpoint position, the determination of an evaluation app, the generation of a confirmation image, and the like are executed by a single computer and a case where each process is executed by a different computer. Further, the execution of each process by a predetermined computer includes causing another computer to execute a part or all of the processes and acquiring a result thereof.

In other words, the information processing apparatus, the information processing method, the program, and the information processing system according to the present technology are also applicable to a configuration of cloud computing in which a single function is shared and cooperatively processed by a plurality of apparatuses through a network. The configurations of the viewpoint-position detection unit, the determination unit, the image generation unit, and the like; the control flow of the communication system; and the like described with reference to the respective figures are merely embodiments, and any modifications may be made thereto without departing from the spirit of the present technology. In other words, any other configurations or algorithms for the purpose of practicing the present technology may be adopted.

Note that the effects described in the present disclosure are not limitative but are merely illustrative, and other effects may be provided. The description on the plurality of effects does not mean that those effects are not necessarily exerted at the same time. It means that at least any of the effects described above is obtained depending on conditions or the like, and as a matter of course, effects not described in the present disclosure may be exerted.

At least two of the characteristic portions according to each embodiment described above can be combined. In other words, the various characteristic portions described in each embodiment may be discretionarily combined without distinguishing between the embodiments.

Note that the present technology may also take the following configurations.

(1)

An information processing apparatus, including
an image generation unit that generates a confirmation image regarding crosstalk on the basis of a viewpoint position of a user.
   (2)

The information processing apparatus according to (1), in which
the confirmation image includes
   a left-eye image that enters a left eye of the user, and
   a right-eye image that enters a right eye of the user and is different from the left-eye image.
      (3)

The information processing apparatus according to (2), in which
the left-eye image includes a predetermined pattern,
the right-eye image includes a predetermined pattern, and
the predetermined pattern includes at least one of a position of an object, a luminance of the object, a depth of the object, or a shape of the object.
   (4)

The information processing apparatus according to (3), further including
a determination unit that determines whether the user is closing the left eye or the right eye on the basis of a captured image in which the user appears.
   (5)

The information processing apparatus according to (4), in which
the image generation unit generates, on the basis of a determination result of the determination unit, the confirmation image based on a difference threshold of the user.
   (6)

The information processing apparatus according to (4), in which
the image generation unit generates the confirmation image including the predetermined pattern with which whether the user performs visual recognition with the left eye or the right eye can be confirmed.
   (7)

The information processing apparatus according to (4), in which
the image generation unit generates, on the basis of a determination result of the determination unit, the left-eye image or the right-eye image that includes luminance information regarding a crosstalk value when an inspection is performed at a predetermined timing.
   (8)

The information processing apparatus according to (3), in which
the confirmation image is an image based on a display parameter regarding display of the predetermined pattern, and
the image generation unit generates the left-eye image or the right-eye image that is based on a first display parameter when an inspection is performed at a predetermined timing, and generates another image that is based on a second display parameter different from the first display parameter.
   (9)

The information processing apparatus according to (1), further including
a guide image generation unit that generates, on the basis of the viewpoint position, a guide image that guides the user to a position suitable to observe the confirmation image.
   (10)

An information processing method that is executed by a computer system, including
generating a confirmation image regarding crosstalk on the basis of a viewpoint position of a user.
   (11)

A program that causes a computer system to execute
generating a confirmation image regarding crosstalk on the basis of a viewpoint position of a user.
   (12)

An information processing system, including:
a camera that captures an image of a user;
an information processing apparatus including an image generation unit that generates a confirmation image regarding crosstalk on the basis of a viewpoint position of the user; and
an image display apparatus that displays the confirmation image.
   (13)

The information processing system according to (12), in which
the camera captures the confirmation image reflected by a mirror, and
the information processing apparatus includes a crosstalk determination unit that determines occurrence and degree of the crosstalk on the basis of the reflected confirmation image.
   (14)

The information processing system according to (12), in which
the image display apparatus displays, for the user, an image formed from a left-eye image and a right-eye image, and
the information processing apparatus includes a second image generation unit that generates an image that guides the user to a position suitable to observe the image.

### REFERENCE SIGNS LIST

1 glasses-free stereoscopic display
10 information processing apparatus
12 determination unit
13 image generation unit
15 confirmation image generation unit
16 guide image generation unit
100 information processing system

1. An information processing apparatus, comprising
an image generation unit that generates a confirmation image regarding crosstalk on a basis of a viewpoint position of a user.

2. The information processing apparatus according to claim 1, wherein
the confirmation image includes
a left-eye image that enters a left eye of the user, and
a right-eye image that enters a right eye of the user and is different from the left-eye image.

3. The information processing apparatus according to claim 2, wherein
the left-eye image includes a predetermined pattern,
the right-eye image includes a predetermined pattern, and
the predetermined pattern includes at least one of a position of an object, a luminance of the object, a depth of the object, or a shape of the object.

4. The information processing apparatus according to claim 3, further comprising
a determination unit that determines whether the user is closing the left eye or the right eye on a basis of a captured image in which the user appears.

5. The information processing apparatus according to claim 4, wherein
the image generation unit generates, on a basis of a determination result of the determination unit, the confirmation image based on a difference threshold of the user.

6. The information processing apparatus according to claim 4, wherein
the image generation unit generates the confirmation image including the predetermined pattern with which whether the user performs visual recognition with the left eye or the right eye can be confirmed.

7. The information processing apparatus according to claim 4, wherein
the image generation unit generates, on a basis of a determination result of the determination unit, the left-eye image or the right-eye image that includes luminance information regarding a crosstalk value when an inspection is performed at a predetermined timing.

8. The information processing apparatus according to claim 3, wherein
the confirmation image is an image based on a display parameter regarding display of the predetermined pattern, and
the image generation unit generates the left-eye image or the right-eye image that is based on a first display parameter when an inspection is performed at a predetermined timing, and generates another image that is based on a second display parameter different from the first display parameter.

9. The information processing apparatus according to claim 1, further comprising
a guide image generation unit that generates, on a basis of the viewpoint position, a guide image that guides the user to a position suitable to observe the confirmation image.

10. An information processing method that is executed by a computer system, comprising
generating a confirmation image regarding crosstalk on a basis of a viewpoint position of a user.

11. A program that causes a computer system to execute
generating a confirmation image regarding crosstalk on a basis of a viewpoint position of a user.

12. An information processing system, comprising:
a camera that captures an image of a user;
an information processing apparatus including an image generation unit that generates a confirmation image regarding crosstalk on a basis of a viewpoint position of the user; and
an image display apparatus that displays the confirmation image.

13. The information processing system according to claim 12, wherein
the camera captures the confirmation image reflected by a mirror, and
the information processing apparatus includes a crosstalk determination unit that determines occurrence and degree of the crosstalk on a basis of the reflected confirmation image.

14. The information processing system according to claim 12, wherein
the image display apparatus displays, for the user, an image formed from a left-eye image and a right-eye image, and
the information processing apparatus includes a second image generation unit that generates an image that guides the user to a position suitable to observe the image.
